(19) United States
(12) Patent Application Publication
(10) Pub. No.: US 2005/0279966 A1
(43) Pub. Date: Dec. 22, 2005

(54) Nanocrystallite glass-ceramic and method for making same

(76) Inventors: Matthew John Dejneka, Corning, NY (US); Christy Lynn Powell, Painted Post, NY (US)

Correspondence Address: CORNING INCORPORATED, SP-TI-3-1, CORNING, NY, 14831, US

(21) Appl. No.: 11/145,132

(22) Filed: Jun. 3, 2005

Related U.S. Application Data
(60) Provisional application No. 60/580,062, filed on Jun. 16, 2004.

(51) Int. Cl. H01F 1/00

(52) U.S. Cl. 252/62.51 C; 252/62.63; 252/62.51 R; 252/62.6; 252/62.56; 252/62.58; 252/62.59; 252/62.64; 252/62.62; 65/17.2; 65/31

(57) ABSTRACT

Glass-ceramic materials are fabricated by infiltrating a porous glass matrix with a precursor for the crystalline phase, drying, chemically reacting the precursor, and firing to produce a consolidated glass-ceramic material. The pore size of the glass matrix constrains the growth and distribution of nanocrystallite size structures. The precursor infiltrates the porous glass matrix as an aqueous solution, organic solvent solution, or molten salt. Chemical reaction steps may include decomposition of salts and reduction or oxidation reactions. Glass-ceramics produced using Fe-containing dopants exhibit properties of magnetism, low Fe²⁺ concentrations, optical transparency in the near-infrared spectrum, and low scattering losses. Increased surface area permits expanded catalytic activity.

### CROSS-REFERENCE TO RELATED APPLICATIONS

This application claims the benefit or priority under 35 U.S.C 119(e) of U.S. Provisional Application Ser. No. 60/580,062, filed on Jun. 16, 2004

### BACKGROUND OF THE INVENTION

1. Field of the Invention

The present invention relates generally to the fabrication of glass-ceramic compositions, and particularly to magnetic and/or transparent glass-ceramic materials impregnated with ferrites.

2. Technical Background

Ferrite or ferrite-bearing materials are used in a wide variety of scientific and industrial applications, such as electronic and electromagnetic components, catalysts and adsorbers, and therapeutic modalities. Optically-transmissive magnetic materials are of particular interest for both passive and active electro- and magneto-optical devices such as isolators, magneto-optical storage media, and electro-optical switching applications.

The first magnetic glass-ceramics were discovered and characterized approximately four decades ago, with examples such as hexagonal hexaferrites and cubic spinel ferrite glass-ceramics subsequently being reported.

Transparency is required for electro- and magneto-optical applications (particularly in the near-infrared wavelength spectrum utilized in many optical communications applications), and the conventional ferrite materials lacked the requisite transparency due to a combination of scattering from the large crystallite size and absorption from Fe²⁺. Efforts to control crystallite size in glass-ceramics include the use of nucleating agents, compositional variations, and heat treatments. However, the glasses must be melted above the liquidus temperature, and the greater the Fe content, the higher the liquidus temperature (which for most ferrite-bearing silicates is well above 1000° C.). Also, since the Fe²⁺/Fe³⁺ ratio increases exponentially with temperature, some amount of Fe²⁺ will generally remain in the glass at the high temperatures required to dissolve the iron oxide. Since glass-ceramics must be quenched to avoid spontaneous devitrification, most of the Fe²⁺ will persist and result in strong infra-red absorption. Thus, commercially meaningful optical applications have generally been restricted to devices which employ single crystals, which can themselves be expensive and compositionally constrained.

The conventional crystalline ferrite materials also provide relatively low available surface areas, which significantly limits their functionality when used as catalytic agents.

From the foregoing, it has been deemed desirable to fabricate a glass-ceramic material exhibiting a generally homogenous distribution of nanocrystalline ferrites, or Fe-containing dopant of controlled crystallite size. It further is desirable to form such glass-ceramic compositions utilizing alkali, alkaline earth, or transition metal ferrites which exhibit magnetic properties and/or transparency to light in the near-infrared spectrum.

### SUMMARY OF THE INVENTION

The present invention relates to glass-ceramic materials which are both magnetic and exhibit an extinction of less than 20 dB/mm at a wavelength between 800 and 2600 nm, and methods for making such materials. In a preferred method for making such materials, a nano-porous glass matrix is impregnated or infiltrated with a dopant precursor for the crystalline phase of the eventual glass-ceramic composition. The dopant precursor is then preferably dried, the precursor materials are chemically reacted and fired to produce a consolidated glass-ceramic material that is magnetic and optically transparent to light having a wavelength in the near-infrared spectrum. The pore size of the glass matrix constrains the growth of the crystallite structures within the glass-ceramic. The crystallite dopant infiltrates the porous glass matrix in fluid form, such as an aqueous solution, an organic solvent solution, or a molten salt. The drying stage is performed at a relatively low temperature, the chemical reaction stage at a moderate or intermediate temperature, and consolidation at a higher temperature relative to the respective stages of the process. Chemical reaction steps may include decomposition of salts, reduction or oxidation reactions, and other reactions designed to transform the precursor into the desired crystalline phase.

Glass-ceramics produced using Fe-containing dopants may include spinel ferrite nanocrystals exhibiting ferromagnetic and superparamagnetic behavior, depending on the initial composition and firing temperature. Optical transparency in the near-infrared spectrum is obtained via oxidizing conditions that prevent Fe²⁺ formation, with the pore size of the glass matrix ensuring nano-sized crystallites to further limit scattering losses.

Using a nitrate salt precursor can achieve magnetization two orders of magnitude (i.e., 100 times) or more greater than that reported using processes wherein Fe(CO)₅ is loaded into porous glass and photolyzed to obtain superparamagnetic and ferrimagnetic particles in glasses after heat treatment, or by the use of sol-gel processes to obtain ferrite nanocomposites.

### BRIEF DESCRIPTION OF THE DRAWINGS

FIG. 1 is a flowchart outlining the steps of the process for fabricating the glass-ceramic materials according to the present invention;

FIG. 2 is a diagram showing the magnetic hysteresis loop for selected MnFe₂O₄-doped samples of the glass-ceramic materials made according to the present invention;

FIG. 3. is a diagram showing the magnetic hysteresis loop for 1.5 Molar BaFe₁₂O₁₉-doped samples of the glass-ceramic materials made according to the present invention;

FIG. 4. is a diagram showing the magnetic hysteresis loop for 1.5 Molar CoFe₂O₄-doped samples of the glass-ceramic materials made according to the present invention;

FIG. 5. is a diagram showing the magnetic hysteresis loop for 1.5 Molar CuFe₂O₄-doped samples of the glass-ceramic materials made according to the present invention;

FIG. 6. is a diagram showing the optical extinction for 0.1 Molar FeFe₂O₄-doped samples of the glass-ceramic materials made according to the present invention;

FIG. 7. is a diagram showing the optical extinction for 1.5 Molar CoFe₂O₄-doped samples of the glass-ceramic materials made according to the present invention;

FIG. 8. is a diagram showing the optical extinction for 1.5 Molar MnFe₂O₄-doped samples of the glass-ceramic materials made according to the present invention;

FIG. 9. is a diagram showing the optical extinction for 1.5 Molar NiFe₂O₄-doped samples of the glass-ceramic materials made according to the present invention; and

FIG. 10. is a diagram showing the comparison of optical extinction for 1.5 Molar Ferrite-doped samples of the glass-ceramic materials made according to the present invention.

### DETAILED DESCRIPTION

The invention will now be described in detail with reference to a few exemplary embodiments, as further illustrated in the accompanying tables and drawing Figures. In the following description, numerous specific details are set forth in order to provide a thorough understanding of the invention. However, it will be apparent to one skilled in the art that the invention may be practiced without some or all of these specific details. In other instances, well-known features and/or process steps have not been described in detail in order to not unnecessarily obscure the invention. The features and advantages of the invention may be better understood with reference to the drawing Figures and discussions that follow.

Referring particularly to FIG. 1, it may be seen that the present method 10 includes a plurality of steps that may be generally described as follows:
Providing a porous glass matrix of predetermined pore size and distribution;
Infiltrating a fluid dopant precursor for the crystalline phase of the glass-ceramic into the porous glass matrix;
Drying the doped matrix structure at a relatively low temperature;
Chemically reacting the remaining dopant at a moderate or intermediate temperature to produce a desired transformation in the dopant precursor;
Consolidating the glass matrix by firing at a higher relative temperature to form the glass-ceramic material having the desired composition, size, and distribution of the crystalline phase.

A porous glass matrix may be fabricated using a precursor borosilicate glass which is heat-treated to separate into a silica-rich matrix phase and a borate-rich second phase. The borate phase is highly soluble in acids such as nitric acid, and may be removed or leached out to render a porous silica-rich glass matrix having a desired porosity profile, including a predetermined pore size and distribution. The glass matrix is on the order of approximately 96% silica glass. The general process for forming such a porous silica glass matrix was initially described in U.S. Pat. Nos. 2,215,039 and 2,286,275, and further techniques have subsequently been reported extensively in the patent and general literature, and the processes for forming such porous glass matrices and controlling the pore size and distribution profile are deemed to be well known to those of ordinary skill in the art of borosilicate glass composition and manufacture.

Porous Vycor® (available from Corning Incorporated, One Riverfront Plaza, Corning N.Y. 14831 under Corning Glass Code 7930) provides a suitable glass matrix material for fabricating the glass-ceramics further described herein as exemplary embodiments. The glass has 28% porosity, with an interconnected network of 10 nm diameter pores or channels. The porous glass matrix is impregnated or infiltrated with a fluid dopant precursor for the desired crystallite dopant, and then heated at appropriate temperatures and cycle times to first dry and then optionally decompose or chemically react the precursor, and finally consolidate the glass into a dense glass-ceramic. The pore size of the glass matrix physically limits the growth of crystal structures within the matrix, thus constraining the crystalline phase of the resulting glass-ceramic to a predetermined profile of crystallite size, distribution, and homogeneity.

For the particular examples discussed herein, drying temperatures on the order of about 90° C. have proven suitable. The chemical reaction step (which is optionally applied to treat some precursors by decomposing salts, oxidizing or reducing constituents, or other compound-specific chemical reactions) is generally carried out in the range of 200° C. to 800° C. The step of consolidating or densifying the doped glass matrix is generally conducted at temperatures in the range of 900° C. to 1250° C. or above and more preferably between 975 and 1050° C.).

As such, it may be appreciated that the drying stage is performed at a relatively low temperature, the chemical reaction stage is performed at a moderate or intermediate temperature, and the consolidation stage is performed at a relatively high temperature when comparing the respective stages of the overall process. However, different glass matrix compositions and dopant precursor formulations (including solvents, when necessary) may require different drying, reaction, and consolidation temperatures to yield the desired glass-ceramic materials. It may be appreciated that some chemical reactions may be induced at lower temperatures normally suitable for the drying stage, or may proceed at elevated temperatures normally suitable for the consolidation stage. As such, it is understood that the chemical reaction stage—to the extent it is necessarily or optionally conducted in practicing any particular embodiment of the subject invention—may overlap with and be accomplished in whole or in part simultaneously with the drying and/or consolidation stages. It is further understood that reference to particular stages within this description is not intended to imply any requirement of discrete, sequential, or temporally-separated steps, but those stages may be conducted in a continuous, variable, or fluctuating process flow. It is also understood that certain stages or steps may be repeated in whole or in part to achieve particular properties of the resulting glass-ceramic without diverging from the subject invention.

To increase the dopant loading of the glass ceramic, multiple infiltrations of the dopant precursor can be employed. To facilitate this result, after the first infiltration, the precursors may be heated or otherwise chemically decomposed to an insoluble state to “fix” them in place and empty the remaining pore volume of anything that could displace subsequent dopant precursor. After fixing, the material can be infiltrated with additional dopant precursor and fixed again multiple times to increase the ultimate solids loading until nearly all the pore space is filled, if desired. Likewise, if desired the pore space can also be increased by etching the glass with ammonium bifluoride and mineral acid as taught by Elmer “Porous and reconstructed glasses” in Engineered materials handbook Vol 4 S. J. Schneider ed, ASM International 1991 pp 427-432. Etching and multiple dopings can also be combined to obtain doping levels exceeding the original pore space of the glass.

Formation of Fe-containing glass-ceramic materials having properties such as magnetism and optical transparency in the near-infrared portion of the spectrum are of particular interest for a variety of scientific, commercial, and industrial applications, and have therefore been used herein to describe several representative examples of the subject method for making glass-ceramics having a controlled nanocrystalline phase. By magnetic, we mean that the material exhibits a hysteresis loop when exposed to a magnetic field. In preferred embodiments of the invention, the material exhibits a saturation magnetization of greater than 0.05 emu/g, more preferably greater than 0.5 emu/g, and most preferably greater than 5 emu/g. By optically transparent in the near-infrared region of the spectrum, we mean that the material exhibits an extinction of less than 20 dB/mm at a wavelength between 800 and 2600 nm. In preferred embodiments of the invention, the material exhibits an extinction of less than 6 dB/mm, more preferably less than 4 dB/mm, and most preferably less than 2 dB/mm at a wavelength between 800 and 2600 nm.

One benefit of the present process when considering Fe-containing precursors or dopants is that consolidation temperatures lower than might conventionally be used in other fabrication processes involving ferrites prevent the formation of Fe²⁺, which absorbs light in the near-infrared spectrum and inhibits optical transparency. In addition the open porosity of the glass matrix material enables the use of oxidizing atmospheres like O₂ to further suppress residual formation of Fe²⁺. Finally, the Fe species are not dissolved in the glass matrix using the impregnation approach described herein, so higher proportions (and in some cases nearly all) of the Fe dopant can be partitioned into the useful crystalline phase.

Several representative examples are described herein to facilitate a better understanding of the subject invention by those skilled in the art, with the precursor compositions, relevant process parameters, and empirical results being further recited in Table I, below. In these exemplary samples, except as otherwise noted herein, porous Vycor® was cut into 25×25×1 mm plates and then cleaned by heating to 550° C. in air for approximately one hour. The pieces were maintained at 150° C. until further use to prevent contamination with any moisture and hydrocarbons within the environment. The plates were then impregnated or infiltrated for approximately one hour in aqueous or molten nitrate salts at 90° C. as listed in Table I. The plates were dried overnight at 95° C., heated at 1° C./min to 200° C. to drive off any remaining water, then heated at 2° C./min to the final sintering temperature, held there for approximately four hours, and cooled at 10° C./min to ambient room temperature.

Optical transmission measurements were performed on a PerkinElmer Lambda 900 spectrophotometer with 2 nm resolution on the “as-formed” surfaces. X-ray diffraction (XRD) measurements were made on a Philips diffractometer on powdered samples with 0.001 nm resolution from 5° to 70° two-theta in 0.01 nm increments. Magnetic hysteresis loops were recorded in-plane at ambient room temperature using a Lakeshore vibrating sample magnetometer to applied fields of ±12 kOe (1.2 T).

TABLE I

| | | | | | | | Magnetic Properties | | | |
|---|---|---|---|---|---|---|---|---|---|---|
| Sample | Fe(NO3)3 | Codopant | | Firing | | XRD | Ms | Mr | Hc | % Ms |
| Name | Molarity | Codopant | Molarity | Temp ° C. | Atmos | Phase | (emu/g) | (emu/g) | (Oe) | (%) |
| BaFe12O19 | 1.1 | Ba(NO3)2 | 0.092 | 900 | Air | | 0.270 | 0.000 | 0 | 0.36 |
| CoFe2O4 | 1.1 | Co(NO3)2.6H2O | 0.55 | 900 | Air | | 1.500 | 0.030 | 25 | 1.87 |
| CuFe2O4 | 1.1 | Cu(NO3)2.3H2O | 0.55 | 900 | Air | | 1.100 | 0.000 | 0 | 4.36 |
| FeFe2O4 | 0.2 | | | 900 | Air | | 0.140 | 0.000 | 0 | 0.15 |
| Li.5Fe2.5O4 | 1.1 | Li(NO3) | 0.22 | 900 | Air | | 0.300 | 0.003 | 50 | 0.46 |
| MgFe2O4 | 1.1 | Mn(NO3)2.6H2O | 0.55 | 900 | Air | | 0.600 | 0.000 | 0 | 2.26 |
| MnFe2O4 | 1.1 | Mn(NO3)2.6H2O | 0.55 | 900 | Air | | 1.000 | 0.000 | 0 | 1.25 |
| NiFe2O4 | 1.1 | Ni(NO3)2.6H2O | 0.55 | 900 | Air | | 0.750 | 0.000 0 | 1.49 | |
| Y3Al5O12 | 1.5 | Al(NO3)3.H2O | 0.9 | 900 | Air | | | | | |
| Y3Fe5O12 | 1.5 | Y(NO3)3.6H2O | 0.9 | 900 | Air | | 0.190 | 0.025 | 500 | 0.70 |
| ZnFe2O4 | 1.1 | Zn(NO3)2.6H2O | 0.55 | 900 | Air | | 0.320 | 0.000 | 0 | |
| BaFe12O19 | 1.1 | Ba(NO3)2 | 0.092 | 1100 | Air | BaFe12O19, Hematite | 0.210 | 0.077 | 1480 | 0.29 |
| CoFe2O4 | 1.1 | Co(NO3)2.6H2O | 0.55 | 1100 | Air | Spinel | 2.500 | 0.300 | 70 | 3.11 |
| CuFe2O4 | 1.1 | Cu(NO3)2.3H2O | 0.55 | 1100 | Air | | | | | 0.00 |
| FeFe2O4 | 0.2 | | | 1100 | Air | Hematite | 0.140 | 0.047 | 1040 | 0.15 |
| Li.5Fe2.5O4 | 1.1 | Li(NO3) | 0.22 | 1100 | Air | Cristobalite, Hematite | Crumbled due to cristobablite devit | | | |
| MgFe2O4 | 1.1 | Mg(NO3)2.6H2O | 0.55 | 1100 | Air | Spinel | 0.900 | 0.000 | 0 | 3.39 |
| MnFe2O4 | 1.1 | Mn(NO3)2.6H2O | 0.55 | 1100 | Air | Spinel | 1.700 | 0.000 | 0 | 2.13 |
| NiFe2O4 | 1.1 | Ni(NO3)2.6H2O | 0.55 | 1100 | Air | Spinel | 1.10 | 0.00 | 0 | 2.19 |
| Y3Al5O12 | 1.5 | Al(NO3)3.H2O | 0.9 | 1100 | Air | | | | | |
| Y3Fe5O12 | 1.5 | Y(NO3)3.6H2O | 0.9 | 1100 | Air | Hematite, Keivyite | 0.060 | 0.000 | 0 | 0.30 |
| ZnFe2O4 | 1.1 | Zn(NO3)2.6H2O | 0.55 | 1100 | Air | Spinel | 0.200 | 0.000 | 0 | |
| BaFe12O19 | 3.0 | Ba(NO3)2 | 0.25 | 900 | O2 | BaFe12O19, Hematite | 0.718 | 0.092 | 286.5 | 1.00 |
| Bi3Fe5O12 | 3.0 | Bi(NO3)3.6H2O | 1.8 | 900 | O2 | Hematite | 0.110 | 0.005 | 130.5 | 0.66 |
| CoFe2O4 | 3.0 | Co(NO3)2.6H2O | 1.5 | 900 | O2 | Spinel | 4.300 | 0.787 | 139.5 | 5.35 |
| CuFe2O4 | 3.0 | Cu(NO3)2.3H2O | 1.5 | 900 | O2 | Spinel | 3.720 | 0.330 | 19.5 | 14.74 |
| FeFe2O4 | 3.0 | | | 900 | O2 | Hematite | 0.646 | 0.085 | 289.5 | 0.70 |
| Li.5Fe2.5O4 | 3.0 | Li(NO3) | 0.6 | 900 | O2 | Cristobalite, Hematite | 0.052 | 0.005 | 282 | 0.08 |
| MgFe2O4 | 3.0 | Mg(NO3)2.6H2O | 1.5 | 900 | O2 | Spinel | 1.391 | 0.042 | 21 | 5.15 |
| MnFe2O4 | 3.0 | Mn(NO3)2.6H2O | 1.5 | 900 | O2 | Spinel | 2.353 | 0.181 | 18 | 2.94 |
| NiFe2O4 | 3.0 | Ni(NO3)2.6H2O | 1.5 | 900 | O2 | Spinel | 1.987 | 0.019 | 21 | 3.96 |
| Y3Fe5O12 | 3.0 | Y(NO3)3.6H2O | 1.8 | 900 | O2 | Hematite, Keivyite | 0.179 | 0.040 | 930 | 0.66 |
| ZnFe2O4 | 3.0 | Zn(NO3)2.6H2O | 1.5 | 900 | O2 | Spinel | 0.026 | 0.000 | 203 | |
| BaFe12O19 | 3.0 | Ba(NO3)2 | 0.25 | 1000 | O2 | BaFe12O19, Hematite | 0.453 | 0.131 | 1985 | 0.63 |
| Bi3Fe5O12 | 3.0 | Bi(NO3)3.5H2O | 1.8 | 1000 | O2 | Crisob, Hematite | 0.091 | 0.001 | 136.5 | 0.55 |
| CoFe2O4 | 3.0 | Co(NO3)2.6H2O | 1.5 | 1000 | O2 | Spinel | 5.263 | 1.306 | 205.5 | 6.55 |
| CuFe2O4 | 3.0 | Cu(NO3)2.3H2O | 1.5 | 1000 | O2 | Cristobalite, Spinel | 4.295 | 1.429 | 24 | 17.02 |
| FeFe2O4 | 3.0 | | | 1000 | O2 | Hematite | 0.483 | 0.137 | 1004 | 0.52 |
| Li.5Fe2O4 | 3.0 | Li(NO3) | 0.6 | 1000 | O2 | Cristobalite, Hematite | 0.024 | 0.003 | 690 | 0.04 |
| MgFe2O4 | 3.0 | Mg(NO3)2.6H2O | 1.5 | 1000 | O2 | Spinel | 1.428 | 0.074 | 21 | 5.29 |
| MnFe2O4 | 3.1 | Mn(NO3)2.6H2O | 1.543 | 1000 | Air | Spinel | 5.600 | 0.000 | 0 | 7.00 |
| MnFe2O4 | 3.0 | Mn(NO3)2.6H2O | 1.5 | 1000 | O2 | Spinel | 3.636 | 0.484 | 24 | 4.54 |
| NiFe2O4 | 3.0 | Ni(NO3)2.6H2O | 1.5 | 1000 | O2 | Spinel | 2.304 | 0.067 | 25.5 | 4.59 |
| Y3Fe5O12 | 3.0 | Y(NO3)3.6H2O | 1.8 | 1000 | O2 | Hematite, Keivite | 0.061 | 0.002 | 43.5 | 0.23 |
| ZnFe2O4 | 3.0 | Zn(NO3)2.6H2O | 1.5 | 1000 | O2 | Spinel | 0.017 | 0.000 | −259.2 | |
| BaFe12O19 | 3.0 | Ba(NO3)2 | 0.25 | 900-48hs | O2 | BaFe12O19, Hematite | 0.680 | 0.104 | 289.5 | 0.94 |
| Bi3Fe5O12 | 3.0 | Bi(NO3)3.5H2O | 1.8 | 900-48hs | O2 | Cristob, Hematite | 0.041 | 0.002 | 1006 | 0.25 |
| CoFe2O4 | 3.0 | Co(NO3)2.6H2O | 1.5 | 900-48hs | O2 | Spinel | 4.122 | 0.749 | 130.5 | 5.13 |
| CuFe2O4 | 3.0 | Cu(NO3)2.3H2O | 1.5 | 900-48hs | O2 | Cristobalite, Spinel | 3.614 | 0.606 | 21 | 14.32 |
| FeFe2O4 | 3.0 | | | 900-48hs | O2 | Hematite | 0.612 | 0.096 | 283.5 | 0.67 |
| Li.5Fe2.5O4 | 3.0 | Li(NO3) | 0.6 | 900-48hs | O2 | Cristobalite, Hematite | 0.023 | 0.001 | 370.5 | 0.04 |
| MgFe2O4 | 3.0 | Mg(NO3)2.6H2O | 1.5 | 900-48hs | Spinel | 1.754 | 0.060 | 19.5 | 6.49 | |
| MnFe2O4 | 3.0 | Mn(NO3)2.6H2O | 1.5 | 900-48hs | O2 | Spinel | 2.798 | 0.265 | 21 | 3.50 |
| NiFe2O4 | 3.0 | Ni(NO3)2.6H2O | 1.5 | 900-48hs | O2 | Spinel | 1.962 | 0.032 | 19.5 | 3.91 |
| Y3Fe5O12 | 3.0 | Y(NO3)3.6H2O | 1.8 | 900-48hs | O2 | Hematite, Keivite | 0.119 | 0.011 | 370.5 | 0.44 |
| ZnFe2O4 | 3.0 | Zn(NO3)2.6H2O | 1.5 | 900-48hs | O2 | Spinel | 0.015 | 0.000 | −394.8 | |

| | | UV edge | | | |
|---|---|---|---|---|---|
| Sample | Theoretical | 10 dB/mm | 1550 nm | Wt Gain | |
| Name | Ms (emu/g) | (nm) | (dB/nm) | (%) | % Ms/Wt gain |
| BaFe12O19 | 72.0 | 625 | 0.558 | | |
| CoFe2O4 | 80.3 | opaque | opaque | | |
| CuFe2O4 | 25.2 | 848 | 1.521 | | |
| FeFe2O4 | 92.0 | 592 | 0.449 | | |
| Li.5Fe2.5O4 | 65.3 | 625 | 0.872 | | |
| MgFe2O4 | 26.5 | 603 | 0.782 | | |
| MnFe2O4 | 80.0 | 789 | 0.645 | | |
| NiFe2O4 | 50.2 | 668 | 0.485 | | |
| Y3Al5O12 | | 262 | 0.263 | | |
| Y3Fe5O12 | 27.1 | 665 | 0.492 | | |
| ZnFe2O4 | 0.0 | 613 | 0.857 | | |
| BaFe12O19 | 72.0 | 653 | 3.949 | | |
| CoFe2O4 | 80.3 | 874 | 11.467 | | |
| CuFe2O4 | 25.2 | crumbled | | | |
| FeFe2O4 | 92.0 | 582 | 1.197 | | |
| Li.5Fe2.5O4 | 65.3 | crumbled | | | |
| MgFe2O4 | 26.5 | (OD = 1.16) | opaque | | |
| MnFe2O4 | 80.0 | 895 | 1.499 | | |
| NiFe2O4 | 50.2 | 695 | 7.268 | | |
| Y3Al5O12 | | 242 | 0.832 | | |
| Y3Fe5O12 | 27.1 | 819 | 3.243 | | |
| ZnFe2O4 | 0.0 | 643 | 6.719 | | |
| BaFe12O19 | 72.0 | 826 | 0.458 | 4.73% | 21.11 |
| Bi3Fe5O12 | 16.6 | 1045 | 2.329 | 15.32% | 0.00 |
| CoFe2O4 | 80.3 | 1081 | 10.554 | 7.19% | 74.41 |
| CuFe2O4 | 25.2 | 1951 | opaque | 8.20% | 179.86 |
| FeFe2O4 | 92.0 | 828 | 0.724 | 7.15% | 9.82 |
| Li.5Fe2.5O4 | 65.3 | opaque | opaque | | |
| MgFe2O4 | 27.0 | 8660 | 3.287 | 6.16% | 83.61 |
| MnFe2O4 | 80.0 | 1256 | 4.129 | 6.81% | 43.17 |
| NiFe2O4 | 50.2 | 851 | 1.756 | 5.44% | 72.71 |
| Y3Fe5O12 | 27.1 | 754 | 0.796 | 9.98% | 0.00 |
| ZnFe2O4 | 0.0 | 836 | 1.339 | 16.36% | 0.00 |
| BaFe12O19 | 72.0 | 1349 | 8.792 | 6.18% | 10.19 |
| Bi3Fe5O12 | 16.6 | 1738 | 12.749 | 12.18% | 0.00 |
| CoFe2O4 | 80.3 | 2104 | 29.833 | 6.81% | 96.17 |
| CuFe2O4 | 25.2 | opaque | opaque | | |
| FeFe2O4 | 922.0 | 1371 | 8.838 | 6.20% | 8.46 |
| Li.5Fe2.5O4 | 65.3 | opaque | opaque | 6.56% | 0.56 |
| MgFe2O4 | 27.0 | opaque | opaque | 5.60% | 94.42 |
| MnFe2O4 | 80.0 | 1264 | 5.598 | | |
| MnFe2O4 | 80.0 | 1183 | 2.583 | 7.36% | 61.71 |
| NiFe2O4 | 50.2 | 2069 | 17.934 | 6.86% | 66.94 |
| Y3Fe5O12 | 27.1 | 997 | 4.947 | 8.05% | 0.00 |
| ZnFe2O4 | 0.0 | 2441 | 26.045 | 7.13% | 0.00 |
| BaFe12O19 | 72.0 | 874 | 0.797 | | |
| Bi3Fe5O12 | 16.6 | | 0.000 | | |
| CoFe2O4 | 80.3 | 1770 | 18.461 | | |
| CuFe2O4 | 25.2 | 2061 | opaque | | |
| FeFe2O4 | 92.0 | 970 | 6.051 | | |
| Li.5Fe2.5O4 | 65.3 | opaque | opaque | | |
| MgFe2O4 | 27.0 | 2494 | opaque | | |
| MnFe2O4 | 80.0 | 1151 | 2.423 | | |
| NiFe2O4 | 50.2 | 1182 | 7.157 | | |
| Y3Fe5O12 | 27.1 | 887 | 1.894 | | |
| ZnFe2O4 | 0.0 | 1789 | 12.672 | | |

Table I further summarizes the magnetic, IR transmission, XRD and gravimetric data for the doped consolidated glass-ceramics. Theroetical Mₛ values were obtained from J. Smit and H. Wijn, Ferrites, Philips Technical Library Press, Eindhoven, The Netherlands (I1965) at pages 1 57 and 204.

The following discussion reflects several observations deemed noteworthy to those of skill in the art and to aid in further understanding these illustrative examples or embodiments of the present invention, as well as the manners in which variations in composition and dopant formulations, reaction parameters, and process steps will affect or can be adjusted to yield specific results in the eventual glass-ceramic materials being fabricated. It is to be understood that these are merely illustrative examples, and that a wide degree of variation and modification to these parameters and processes can be utilized to achieve specific intended results, and that further properties and characteristics will be identified, observed, and improved upon through routine experimentation, both including those examples set forth herein and by using other dopants to achieve different glass-ceramic materials. As stated above, the field of Fe-containing glass-ceramic materials which exhibit optical transparency or magnetism are of particular interest, and have therefore been used as examples herein, but these same glass-ceramic materials may be of interest for other reasons, in which case other properties or characteristics may render some materials more favorable than or inferior to others for specific applications, and glass-ceramic materials containing dopants or precursors other than pure Fe, ferrites, or other Fe-containing compounds may be of particular interest and yield specific utility because of their characteristics and properties.

By going from a saturated aqueous nitrate salt solution to a pure molten nitrate salt liquid, the molarity of the dopants was enhanced by a factor of three, which in turn increased the saturation magnetization M, by about the same factor. The notable exceptions were the Li_{0.5}Fe_{2.5}O₄ and ZnFe₂O₄ samples, which both decreased by an order of magnitude. The Li_{0.5}Fe_{2.5}O₄ formed cristobalite, while the remainder of the samples formed cubic spinel ferrite and BaFel₁₂O₁₉ hexaferrite phases. The spinel ferrites all had similarly broad XRD peaks, indexed by the appropriate cubic spinel pattern, exhibiting peaks that were wider than the differences in d-spacings between the different spinels. The straight Fe-doped samples did not form spinel (magnetite), and instead formed hematite. Utilizing precursors initially deemed suitable for forming yttrium and bismuth iron garnet phases produced hematite and Keivyite (Y₂Si₂O₇).

Molten nitrate salt infiltration increased the ferrite loading by a factor of three over saturated aqueous solutions, and magnetic glass ceramics with 5-7 wt % of CoFe₂O₄, CuFe₂O₄, MgFe₂O₄, MnFe₂O₄, and NiFe₂O₄ as well as nonmagnetic ZnFe₂O₄ spinel ferrites were obtained. The presence of the silica matrix and oxidizing atmosphere rendered the crystalline phase of the Li_{0.5}Fe_{2.5}O₄, BaFe₁₂O₁₉, FeFe₂O₄, Bi₃Fe₅O₁₂grass-ceramics thermodynamically unstable, resulting in hematite and other less desirable phases for the applications of primary interest herein.

In general, the connected nano-pores of the glass matrix enabled doping while constraining the particle size of the ferrites below about 10 nm, resulting in non-interacting magnetic nanocrystallites with superparamagnetic behavior and materials with near infrared transparency. The best observed combination of magnetic and optical properties for use in optical communications or optical data processing applications from among these representative examples was obtained using MnFe₂O₄ treated at 1000° C., demonstrating saturation magnetization up to 5.6 emu/g and optical losses below 3 dB/mm at 1550 nm. Ferromagnetic behavior can also be obtained with coercivities of about 2000 Oe in hematite and barium hexaferrite glass-ceramics. Thus, these materials represent exemplary candidates for optical switching and data-storage applications.

The weight gains for the heavily-loaded samples are also shown in Table I. All of the samples gained about 5-7 wt % of ferrite by the molten salt impregnation process. A comparison of the saturation magnetizations Mₛ for the prepared samples and that of the pure ferrites reveals that the CoFe₂O₄, MgFe₂O₄, MnFe₂O₄, and NiFe₂O₄ samples were also in the 4-7% range. The last column in Table I is the measured percentage of Mₛ that would be expected were the entire weight gain due to pure ferrite formation. The CoFe₂O₄ and MgFe₂O₄ samples were nearly 100% by 1000° C. (indicating complete conversion of the precursors to spinel), whereas the MnFe₂O₄, and NiFe₂O₄ samples were about two-thirds of their expected values. The pure Fe-doped sample also exhibited low Mₛ, as expected because hematite (Fe₂O₃) is formed rather than the magnetite (Fe₃O₄) spinel. Li_{0.5}Fe_{2.5}O₄ exhibits a low % Mₛ due to the formation of cristobalite and hematite instead of spinel, whereas CuFe₂O₄ exhibits a much higher than expected % Mₛ at 900° C. and crumbled at 1000° C. due to cristobalite devitrification. (Though accurate weighing was not possible for samples which crumbled, it was interesting to note remaining segments large enough to permit VSM measurement revealed the highest remnant magnetization Mᵣ at 1.429 emu/g of all the representative samples.)

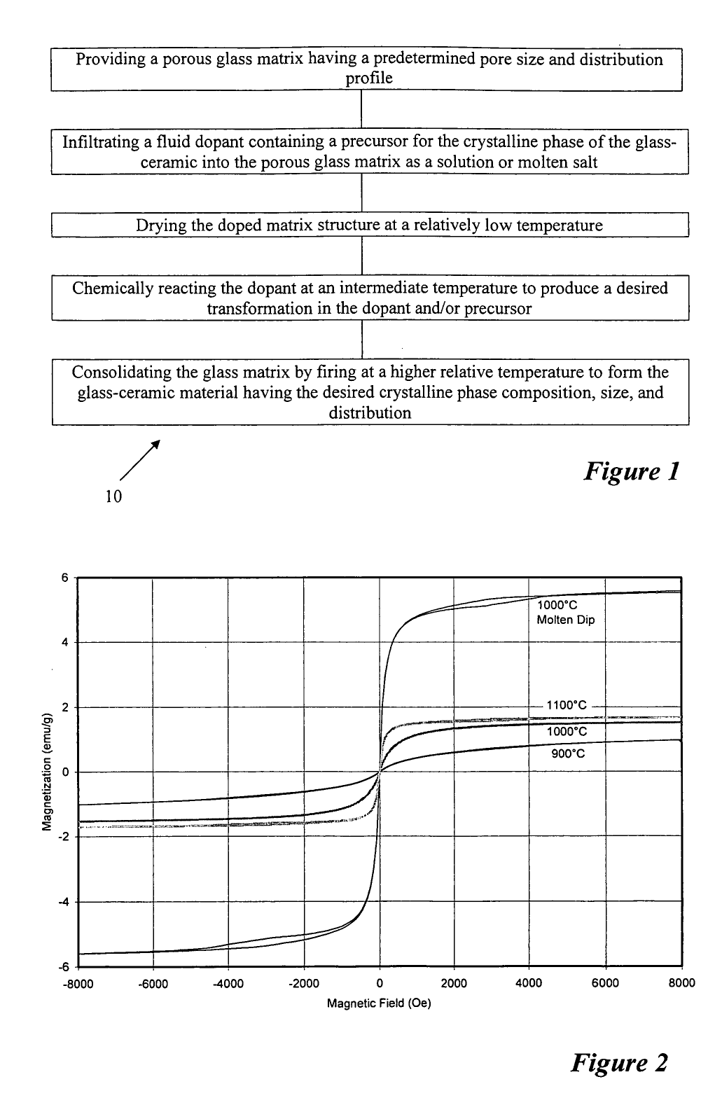

Referring to FIG. 2, the magnetic hysterisis loops for the MnFe₂O₄ samples are shown. Increasing the heat treatment temperature from 900 to 1100° C. increases the saturation magnetization Mₛ from 1 emu/g to 1.7 emu/g, and the permeability (or slope) from 0.0006 emu/(g*Oe) to 0.004 emu/(g*Oe). Increasing the ferrite loading by going from aqueous solution impregnation to molten salt impregnation resulted in a large increase in Mₛ, to 5.6 emu/g. All the curves exhibited superparamagnetic or closed-loop behavior.

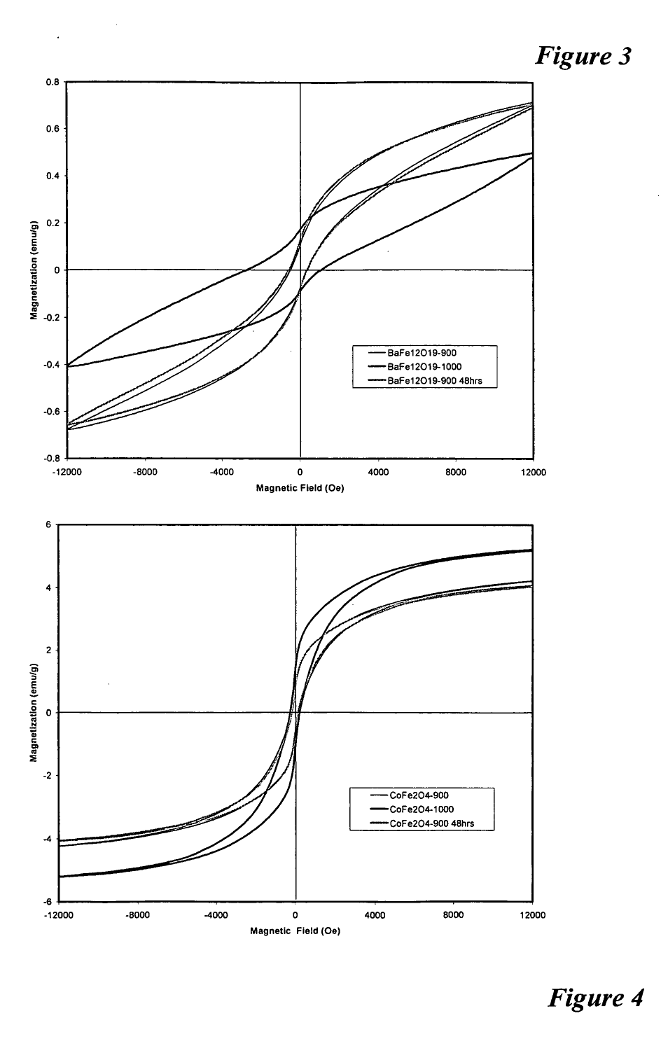

Referring to FIG. 3, the magnetic hysteresis loops for the BaFe₁₂O₁₉ samples are shown. The curves show typical ferromagnetic behavior with an open loop. The coercive field H_{c} increases from 290 Oe to 1985 Oe as the firing temperature is increased from 900° C. to 1000° C. Very similar curves were also obtained for the Fe-only doped sample, but with a slightly larger coercive field of 2300 Oe.

The CoFe₂O₄ samples had a slightly open loop with coercive field of 150 Oe when heat treated at 900° C., increasing to 220 Oe at 1000° C. as shown in FIG. 4 and Table I. The saturation magnetization also increased from 4.30 emu/g to 5.26 emu/g over this temperature range, while the 48-hour heat treatment at 900° C. did not significantly alter the loop compared to the standard 4-hour heat treatment at 900° C. The 1000° C. CoFe₂O₄ sample had one of the highest Mₛ values, at 96% of expected based on the sample's 6.8% weight gain.

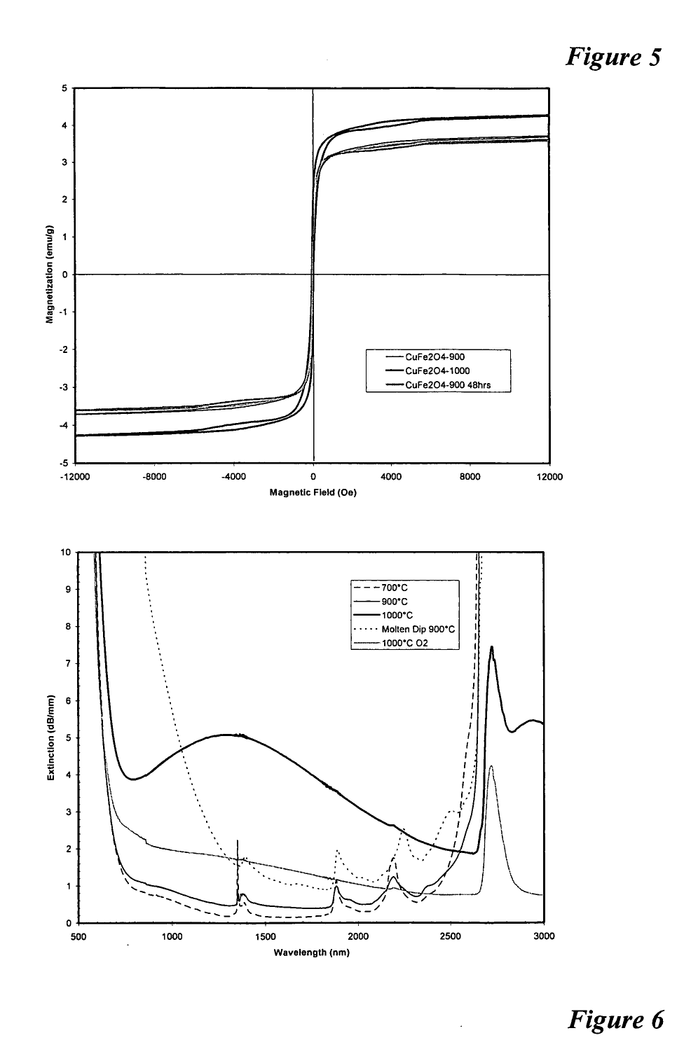

Referring to FIG. 5, the CuFe₂O₄ hysteresis loops exhibit superparamagnetic behavior with closed loops, and H_{c} less than 50 Oe. The 48-hour heat treatment did not result in any significant changes, while firing to 1000° C. increased Mₛ to 4.3 emu/g and resulted in the largest remnant magnetization of 1.4 emu/g from among the representative samples. (Again, sample fragmentation prevented accurate weight gain measurements, but the expected Mₛ would be 1.26 emu/g to 1.76 emu/g based on the nominal 5-7% weight gain).

The majority of samples had a lustrous black appearance after firing. The lightly-doped 0.2 molarity Fe-only samples were visibly transparent with an orange-brown tint. The Li_{0.5}Fe_{2.5}O₄ samples had an orange tint, and were slightly pliable (due to the large amount of micro-cracking caused by massive devitrification). The short wavelength cutoff and loss at 1550 nm are also listed in Table I for all the samples.

The optical absorption curves for the 0.2 molarity Fe-only doped samples are shown in FIG. 6, to demonstrate the effects of Fe alone (without the complication of the other transition metal cations). The samples heated below 900° C. still contained open porosity and resorbed moisture from the air resulting in OH absorption peaks at 1380 and 2720 nm. By 1000° C., the OH overtone at 1380 nm is eliminated, and the fundamental OH stretch at 2720 nm greatly diminishes and no longer saturates the measurement. The appearance of a broad Fe²⁺ band at 1300 nm is also apparent, but can be removed by consolidating in a pure O₂ atmosphere at the same temperature as shown in FIG. 6. Firing in an oxidizing environment produces a useful transmission window between 700 and 2600 nm, where the loss (including Fresnel reflections) is well below 3 dB/mm.

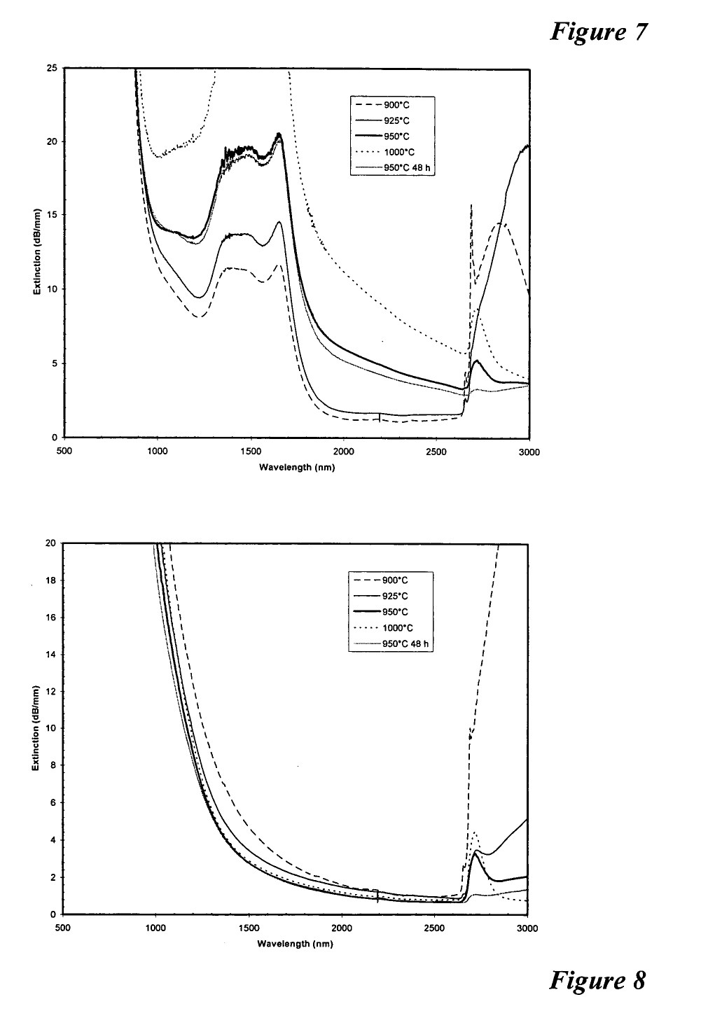

Referring to FIG. 7, the CoFe₂O₄ samples demonstrate similar features to the Fe-only sample at 700° C., but then exhibit a large absorption band right in the middle of the telecommunications window at 1550 nm. Increasing the firing temperature causes an increase in the background loss, while the octahedral Co²⁺ absorption at 1550 nm remains constant.

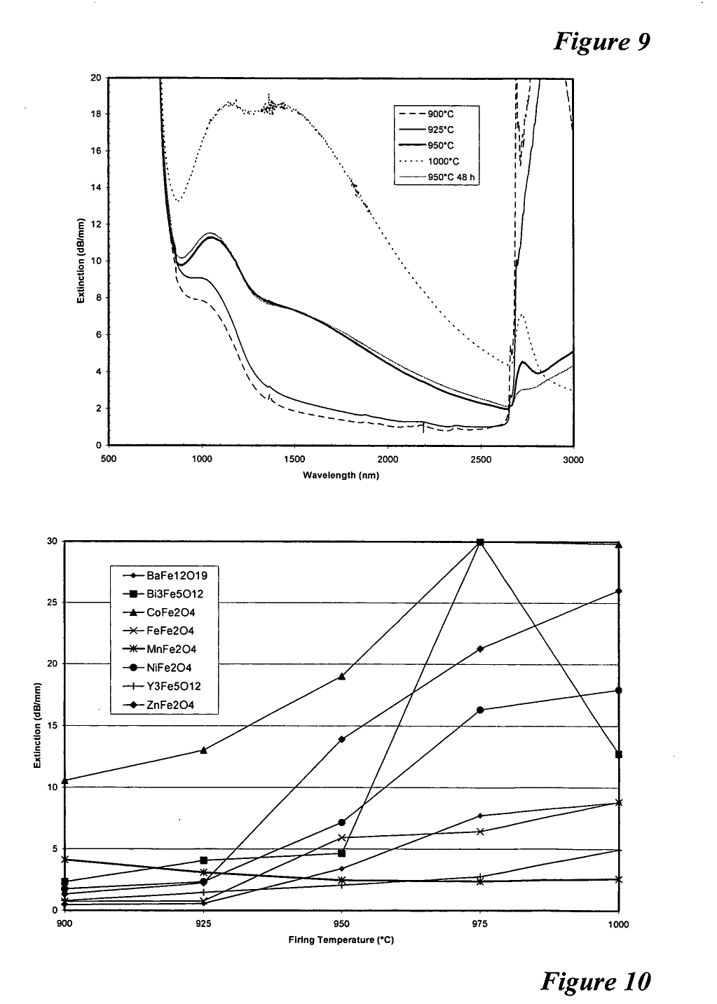

FIG. 8 shows an anomalous behavior of the MnFe₂O₄ samples, which actually become more transparent at shorter wavelengths with increasing firing temperature. Even the most heavily-doped samples exhibit a transmission window between 1500 nm and the water peak at 2600 nm of below 3 dB/mm. The OH peak is about 5 dB/mm, but can be reduced by an order of magnitude to only 0.5 dB/mm with a 48-hour hold at 900° C. The NiFe₂O₄ samples in FIG. 9 show a strong increase in absorption at 1500 nm with increasing firing temperature, going from 1.76 dB/mm at 900° C. to 17.9 dB/mm at 1000° C.

The optical absorption data show the importance in these representative examples of maintaining oxidizing conditions to avoid the formation of Fe²⁺. Since optical transparency was a primary goal when formulating and evaluating these particular examples, oxidizing atmospheres were therefore used and Fe²⁺ was indeed avoided. But this also precludes the formation of magnetite Fe₃O₄, and hence explains the formation of hematite Fe₂O₃ and the low % M, for the FeFe₂O₄ sample.

It is known that superparamagnetic behavior from normally ferromagnetic materials is observed when the particle size is less than the superparamagnetic critical size, and often below 10 nm. It is also known that for glass-ceramics to be transparent, the crystallite size must be much smaller than the wavelength of light. The broad spinel XRD peaks, transparency, and superparamagnetic behavior demonstrated by various of these examples are all indicative of a very small crystallite size, demonstrating that the glass matrix physically constrained the formation of crystalline nanoparticles to a cross-sectional size or volume that was less than the 10 nm channel cross-sectional size or volume previously noted for doped Vycor®.

Ni and Co were the strongest oxidizing agents used in connection with these representative examples, and would normally be expected to perform optimally at keeping the Fe in the trivalent state. The absorption spectra confirmed this, but it should be noted that Ni⁺² and Co⁺² both contribute their own near-IR absorption bands (which will likely limit the use of these materials for many optical applications).

The thermally-increasing absorption band at 1600 nm in the NiFe₂O₄ sample was quite abnormal, since the octahedral Ni²⁺³A₂-³ T₂ transition is characteristic of the peak centered around 1050 nm. The long wavelength transition can be ascribed to Ni²⁺ in a lower field site (such as glass), and explains the drop in the expected % Mₛ for the NiFe₂O₄ sample when the firing temperature was increased from 900° C. to 1000° C. Thus, some of the Ni appears to dissolve into the glass matrix above 900° C., degrading both the optical and magnetic properties of the glass-ceramic. By comparison, others have also observed a decrease in M, for NiFe₂O₄ in sol-gel silica above 1000° C.

Mn is arguably considered the next best oxidizer, and indeed produced samples with the highest transparency and magnetizations. The increase in transparency with temperature of the MnFe₂O₄ sample is opposite to all the other samples, as indicated in FIG. 10. Since the samples treated at or below 900° C. were not fully consolidated and absorbed moisture from the air, the samples get denser and less-porous as the temperature increases. This decrease in residual porosity also decreases the scattering and improves transparency. This can be more prominently observed in non-Fe-bearing samples such as Y₃Al5O₁₂, which are transparent in the visible spectrum where scattering effects are much larger. FIG. 10 also shows the superiority of MnFe₂O₄ over the other spinel glass ceramics which exhibited magnetic behavior. The Y₃Fe₅O₁₂, FeFe₂O₄, and BaFe₁₂O₁₉, samples were the next best for transparency since they do not contain and additional transition metals ions with absorption bands in the near IR.

Because the MnFe₂O₄ samples had the best combination of transparency and saturation magnetization, these samples were measured for Faraday rotation. Faraday rotation measurements were made on 1 mm thick samples at 1550 nm with an applied field of 6 kOe (0.6 T). The 1.5_molarity MnFe₂O₄ samples had Verdet constants of 5, 14.5, and 16.5°/cm at 1550 nm, when fired to 900, 950 and 1000° C. respectively. The 0.55 molarity sample had a Verdet constant of 0.65°/cm when fired to 1100° C. The Verdet constant of the MnFe₂O₄ samples increased with firing temperature similar to Mₛ, but to a greater extent. These thermal enhancements are caused by the increasing fraction of doped salts crystallizing to magnetic spinel ferrite with heat treatment temperature in the temperature range studied. Why the Verdet constant increased more rapidly than Mₛ with treatment temperature is not known, but the effect of crystallite size on Faraday rotation has never been studied since single crystals have been the only transparent materials studied until now. The saturation magnetization and Verdet constant for ferrite doped Vycor™ glass-ceramics will be an order of magnitude lower than the corresponding single crystal ferrites, since the ferrite is only 7 wt % of the composite. The common figure of merit (FOM) used for rotator materials is twice the Faraday rotation (°/cm) divided by the absorption coefficient (cm⁻¹) or (2×16.5°/cm÷2.58 cm⁻¹=12.8°) which is twice the value reported for the spinel single crystals NiFe₂O₄ and Li_{0.5}Fe_{2.5}O₄ (60°). While garnets such as YIG and BIG have no remnant magnetization, they are the material of choice for optical isolators because of their large rotation (175°/cm) and low loss (<0.06cm⁻¹) giving them a FOM >10³°. A secondary hard external magnet or magnetic layer is used to provide the field for rotation for these devices. However for data storage applications, a remnant magnetization is desirable so the written data persists once the applied filed is removed, so the MnFe₂O₄ glass-ceramics may have potential as data storage media.

While the MnFe₂O₄ glass-ceramics exhibit less rotation than iron garnets, they offer superparamagnetic behavior and the processing advantages associated with glass-ceramics that may be useful for future applications. The very large change in magnetization with applied magnetic field exhibited by the superparamagnetic nanocrystallites lowers the threshold required for switching and increases the speed, with rapid turn on and turn off. The glass matrix enables the formation of fibers, waveguides, lenses and various other shapes that are otherwise very difficult to achieve with single crystals.

The glass-ceramic materials disclosed herein may also be useful as catalysts. U.S. Pat. No. 3,931,351 describes the use of various metal ferrites for use as an oxidative dehydrogenation catalyst. U.S. Pat. No. 3,937,748, Chem Mater 12 {12} 3705-14 (2000), and J. Am. Cer. Soc. 85 [7] 1719-24 (2002) describe the use of sol-gel processes to achieve high surface area ferrites for oxidative dehydrogenation catalysis. U.S. Pat. No. 4,916,105 describes the use of ferrites for removing H₂S from automobile exhausts. The glass-ceramic materials of the present invention have the added benefit of being transparent between 800 and 2600 nm. In addition, the glass ceramic materials disclosed herein enables the ferrite nanocrystals to be exposed on accessible surface area within pores, whereas much of the ferrite described in the prior art can be inaccessible, of low surface area, or quickly agglomerates in use.

The inventive method described can be used to make porous glass ceramic materials with very large surface area, e.g. greater than 40 m²/g, more preferably greater than 80 m²/g, and most preferably greater than 120 m²/g. In fact, surface areas as high as 200 m²/g have been achieved using the methods disclosed herein and such surface area was substantially covered with nanocrystalline ferrites. The fine porosity of these materials prevents agglomeration and loss of surface area, while the high connectivity of the pores allows for gas permeability and intimate contact of the reactants with the ferrite catalysts. In one embodiment used to make such a highly porous structure, the porous glass is infiltrated with the appropriate precursors such as a 1:2 molar ratio mixture of molten Mn(NO₃)₂ and Fe(NO₃)₃ for 1 hour. The infiltrated glass is then dried at 90° C. for 4 hours and then heated to 500° C. to decompose the nitrate salts to the active MnFe₂O₄ catalyst. The consolidation step is preferably intentionally avoided in such applications to keep the porosity high and therefore make the catalyst accessible. For optimal surface area retention the impregnated glass is preferably not heated above 900° C. at which point the matrix would otherwise consolidate and collapse the remaining pores. It is even more preferable to keep the maximum heat treatment temperature below 800° C. to maximize surface area and permeability.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A method for making a glass-ceramic material having a crystalline phase, the method comprising the steps of:
providing a porous glass matrix having a predetermined pore size and distribution profile;
infiltrating the porous glass matrix with a dopant precursor for the crystalline phase of the glass-ceramic material, the dopant precursor being generally in a fluid form; chemically reacting the precursor to form the desired dopant, and wherein the resulting glass-ceramic material is magnetic and optically transparency to light having a wavelength in the near-infrared spectrum.

2. The method of claim 1, wherein the dopant comprises a crystalline phase of the glass ceramic and further comprises a compound selected from the group consisting of BaFe]₁₂O₁₉, ZnCr₂O₄, and AFe₂O₄, where A is Co, Cu, Fe, Mg, Mn, Ni, Zn and combinations therof.

3. The method of claim 1, further comprising consolidating the doped glass matrix to form a dense glass-ceramic material.

4. The method of claim 2, wherein the glass-ceramic material exhibits a saturation magnetization greater than 0.05 emu/g.

5. The method of claim 4, wherein the glass-ceramic material exhibits an extinction coefficient of less than 20 dB/mm at a wavelength between 800 and 2600 nm.

6. The method of claim 1 wherein the step of providing the porous glass matrix further comprises:
providing a borosilicate glass substrate having a silica-rich first phase and a borate-rich second phase, the borate-rich second phase being soluble in a solvent; and
separating the borate-rich second phase from the silica-rich first phase using the solvent to render the porous glass matrix having the predetermined pore size and distribution profile.

7. The method of claim 1 wherein the dopant precursor is infiltrated into the porous glass matrix as a fluid selected from the group consisting of an aqueous solution, an organic solvent solution, or a molten salt.

8. The method of claim 1 wherein after the step of infiltrating the dopant into the porous glass matrix, the method further comprises the step of:
drying the doped glass matrix by applying heat.

9. The method of claim 8 further comprising after said drying step, infiltrating the porous glass matrix a second time with said dopant precursor for the crystalline phase of the glass-ceramic material, the dopant precursor being generally in a fluid form.

10. The method of claim 1 wherein after the step of infiltrating the dopant into the porous glass matrix, the method further comprises the steps of:
chemically reacting a portion of the dopant precursor remaining in the pores of the porous glass matrix after drying, to produce a chemical transformation in the dopant precursor or both to from the desired magnetic crystalline phase.

11. The method of claim 10, wherein said chemically reacting step comprises transforming the dopant into an insoluble compound to allow subsequent further doping.

12. The method of claim 1,further comprising the step of consolidating the doped glass matrix at a temperature between about 900 and 1250° C.

13. The method of claim 1, further comprising the step of consolidating the doped glass matrix at a temperature most preferably between 975 and 1050° C.).

14. The method of claim 1 wherein the dopant is comprised of an alkaline earth, or transition metal containing nitrate salt and the dopant precursor is comprised of an Fe-containing compound.

15. A glass-ceramic material which is magnetic and exhibits an extinction coefficient of less than 20 dB/mm at a wavelength between 800 and 2600 nm.

16. The glass-ceramic material of claim 15, wherein said material comprises:
a first glass phase having a predetermined porosity; and
a second crystalline phase composed of one or more Fe-containing nanocrystallite structures distributed generally throughout the glass phase, the one or more Fe-containing nanocrystallite structures being constrained in volume by the predetermined porosity of the first glass phase.

17. The glass-ceramic material of claim 16 wherein the glass-ceramic material exhibits a saturation magnetisation of greater than about 0.05 emu/g.

18. The glass-ceramic material of claim 17 wherein the glass-ceramic material exhibits an extinction less than 6 dB/mm at a wavelength between 800 and 2600 nm.

19. The glass-ceramic material of claim 17 wherein the glass-ceramic material exhibits an extinction less than 6 dB/mm at approximately 1550 nm.

20. The glass-ceramic material of claim 16, wherein the crystalline phase of the glass ceramic comprises a compound selected from the group consisting of BaFe₁₂O₁₉, ZnCr₂O₄, and AFe₂O₄, where A is Co, Cu, Fe, Mg, Mn, Ni, Zn and combinations thereof.

21. The glass-ceramic material of claim 16, wherein the crystalline phase of the glass ceramic comprises MnFe₂O₄.
